(19) United States
(12) Patent Application Publication
(10) Pub. No.: US 2024/0314096 A1
(43) Pub. Date: Sep. 19, 2024

(54) DATA TRANSFER APPARATUS, CONTROL METHOD THEREOF, AND STORAGE MEDIUM

(71) Applicant: Canon Kabushiki Kaisha, Tokyo (JP)

(72) Inventor: KOJI NIWA, Kanagawa (JP)

(21) Appl. No.: 18/592,633

(22) Filed: Mar. 1, 2024

(30) Foreign Application Priority Data
Mar. 15, 2023 (JP) 2023-041328

(51) Int. Cl. H04L 51/212; H04L 51/08; H04L 51/216

(52) U.S. Cl. CPC H04L 51/212; H04L 51/216

(57) ABSTRACT

To improve convenience of a user by mitigating time and effort of setting work relating to address information on a source of transmission in a case where data whose address information on the source of transmission is unknown is received. The data transfer apparatus capable of communicating with a server providing a chat service manages a name representing a source of transmission of received data and address information on the source of transmission in association with each other based on instructions from a user. Then, the data transfer apparatus transfers the received data to an external device and provides the server with information for a user currently utilizing the chat service to grasp that the transfer has been performed.

### BACKGROUND

### Field

The present disclosure relates to a technique to manage address information on the source of data transmission.

### Description of the Related Art

There is a technique to automatically transfer image data (in the following, for convenience, described as “FAX data”) received by utilizing a facsimile device or the like, such a G3 FAX and an internet FAX, to a transmission destination set in advance. Further, it is also possible to notify a user that transfer processing of FAX data has been performed in cooperation with a chat service, such as a business chat. For example, Japanese Patent Laid-Open No. 2021-057806 has disclosed a technique to notify a user that transfer processing has been performed, receive instructions to return a FAX for the received FAX, and so on, in cooperation with the chat service.

In the general chat service, normally it is possible to register one or more talk rooms (UI in charge of the bulletin board function enabling posting and browsing of a message or image among a plurality of users) and one more users and designate them as a notification destination. Consequently, for example, it is considered that information (notification destination determination information) in which the FAX number of the source of transmission of received FAX data and the talk room or the user are associated with each other is stored and used to determine the notification destination. At this time, in a case where the received FAX data is transmitted from a FAX number not included in address book information or the above-described notification destination determination information stored in the facsimile device, it it not possible to perform notification processing. Consequently, in the case such as this, it becomes necessary for a user to add the setting relating to the FAX number of the source of transmission to the address book information or the notification destination determination information. In this case, for example, it is a complicated work to manually update the address book information or the notification destination determination information by accessing the facsimile device, and the work requires user's time and effort.

### SUMMARY

The present disclosure has been made in view of the above-described problem and an object is to improve convenience of a user by mitigating the time and effort of the setting work relating to the address information on the source of transmission in a case where data whose address information on the source of transmission is unknown is received.

The data transfer apparatus according to the present disclosure is a data transfer apparatus capable of communicating with a server providing a chat service and includes: one or more memories storing instructions; and one or more processors executing the instructions to perform: managing a name representing a source of transmission of received data and address information on the source of transmission in association with each other; transferring received data to an external device; and providing the server with information for a user currently utilizing the chat service to grasp that the transfer has been performed, wherein in the managing, based on instructions from the user, the name representing the source of transmission of the received data and the address information on the source of transmission of the received data are managed in association with each other.

Further features of the present disclosure will become apparent from the following description of exemplary embodiments with reference to the attached drawings.

### BRIEF DESCRIPTION OF THE DRAWINGS

FIG. 1 is a diagram showing one example of a system configuration;

FIG. 2 is a diagram showing one example of a configuration of an MFP;

FIG. 3 is a diagram showing one example of a configuration of a user terminal;

FIG. 4 is a diagram showing one example of a configuration of an application server;

FIG. 5 is a diagram showing one example of a software configuration of the MFP;

FIG. 6 is a flowchart relating to registration of transfer setting;

FIG. 7A to FIG. 7E are each a diagram showing one example of a UI screen relating to transfer setting;

FIG. 8 is a diagram showing one example of contents of “transfer setting”;

FIG. 9 is a diagram showing one example of address book data;

FIG. 10 is a flowchart relating to registration of notification setting;

FIG. 11A to FIG. 11C are each a diagram showing one example of a UI screen relating to notification setting;

FIG. 12 is a flowchart relating to setting and registration of a spam address;

FIG. 13A and FIG. 13B are each a diagram showing one example of a UI screen relating to management of a spam address;

FIG. 14A is a flowchart showing a rough flow of transfer processing of received FAX data and transfer notification processing;

FIG. 14B is a flowchart relating to creation of a file name;

FIG. 14C is a flowchart relating to creation of a folder path;

FIG. 14D is a flowchart relating to transfer notification;

FIG. 15 is a diagram showing one example of a chat screen;

FIG. 16A and FIG. 16B are each a diagram showing one example of a chat screen;

FIG. 17 is a sequence diagram showing a flow of processing between apparatuses configuring a system; and

FIG. 18A and FIG. 18B are each a diagram showing one example of a chat screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In the following embodiments, explanation is given by taking a case as an example where FAX data is received, but the data that is the application target of the present invention is not limited to FAX. For example, it is possible to apply the present invention widely by taking various types of data as a target, for example, in such a case where a mail whose address information on the source of transmission is unknown is received.

### First Embodiment

### <System Configuration>

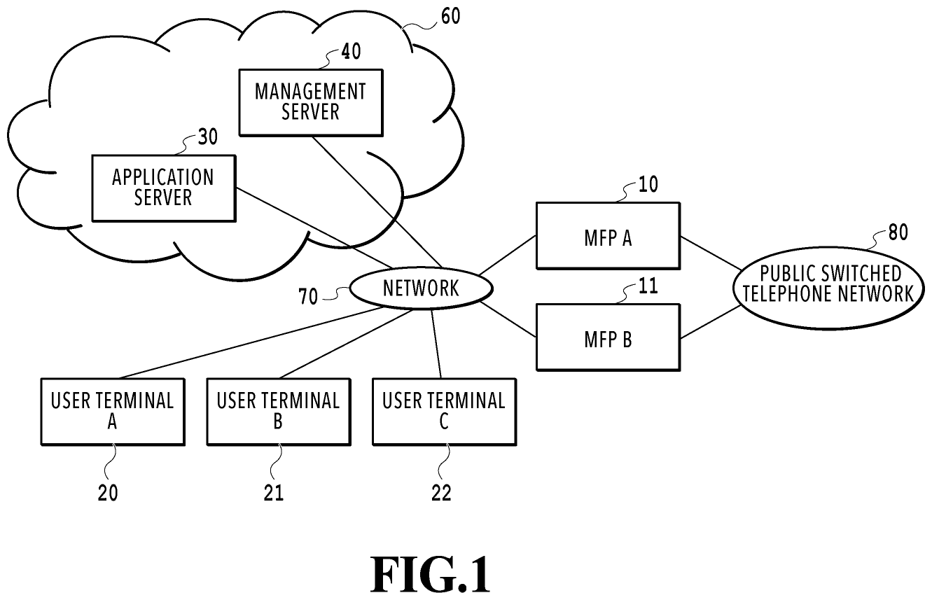

FIG. 1 is a diagram showing one example of the whole configuration of an information processing system according to the present embodiment. The information processing system includes MFPs 10 and 11 as data transfer apparatuses, user terminals 20 to 22 for a user to utilize the chat service, an application server 30 providing the chat service, and a management server 40. Each apparatus is connected to one another via a network 70. The network 70 is a wireless or wired network including WAN or LAN. Further, it is possible for the MFPs 10 and 11 to perform transmission and reception of FAX via a public switched telephone network (PSTN) 80.

The MFPs 10 and 11 are each a multi function peripheral having a plurality of functions as a printer, scanner, FAX device and the like. The MFPs 10 and 11 each have a function to transfer data of an image received by FAX and an image scanned by a scanner to an external device. In a case where a file server (or cloud storage service) is designated in advance as the data transfer destination in this transfer function, for example, it is possible to automatically store the received FAX data in the folder within the file server. Then, by using the FAX number of the source of transmission, the company name associated with the FAX number and the like as the folder name or the file name, it is also possible to make it easier for a user to recognize the received FAX data. It is possible to obtain the FAX number of the source of transmission and the company name associated with the FAX number from, for example, address book data or the like stored in each FAX device (not shown schematically) connected to the public switched telephone network. In FIG. 1, the two MFPs 10 and 11 are shown, but the number of MFPs is arbitrary. It is assumed that the MFPs 10 and 11 of the present embodiment have the same hardware configuration and in the following, the MFP 10 is explained.

The user terminals 20 to 22 each refer to an information processing apparatus, such as a smartphone, a tablet terminal, and a personal computer, which is utilized by a user of the chat service. In FIG. 1, the three user terminals 20 to 22 are shown, but the number of user terminals is arbitrary. A user accesses the application server 30 on a cloud 60 by operating one of the user terminals 20 to 22 and performs transmission and reception of messages with another user and executes an installed application. The user terminals 20 to 22 and the application server 30 are connected to a wired or wireless communication network and each of them is capable of performing transmission and reception of data. In the present embodiment, as one example of the communication network, the public line on the internet is supposed, but a dedicated line may be used. It is assumed that the user terminals 20 to 22 have the same hardware configuration and in the following, the user terminal 20 is explained.

The application server 30 is a cloud server arranged on the cloud 60 and a server providing chat services and the like using a message application 406. The message application 406 is one of applications stored in the application server 30. The application server 30 performs processing as a whole relating to transmission and reception of messages, such as transmission and reception processing of messages and the like with the user terminals 20 to 22 and displaying a UI screen for transmission and reception of messages. The mechanism of transmission and reception of messages in the message application 406 will be described later.

The management server 40 is a cloud server arranged on the cloud 60 and a server providing security-related services, such as issuance of an access token. In the management server 40, user information, channel information, printer information, application information, file information and the like are stored. In the user information, information on a user name, a password, an affiliation, a mail address and the like is stored. In a case where the MFP 10 gives a notification to the message application 406, it is necessary to obtain an access token from the management server 40 for access.

### <Hardware Configuration of Each Apparatus>

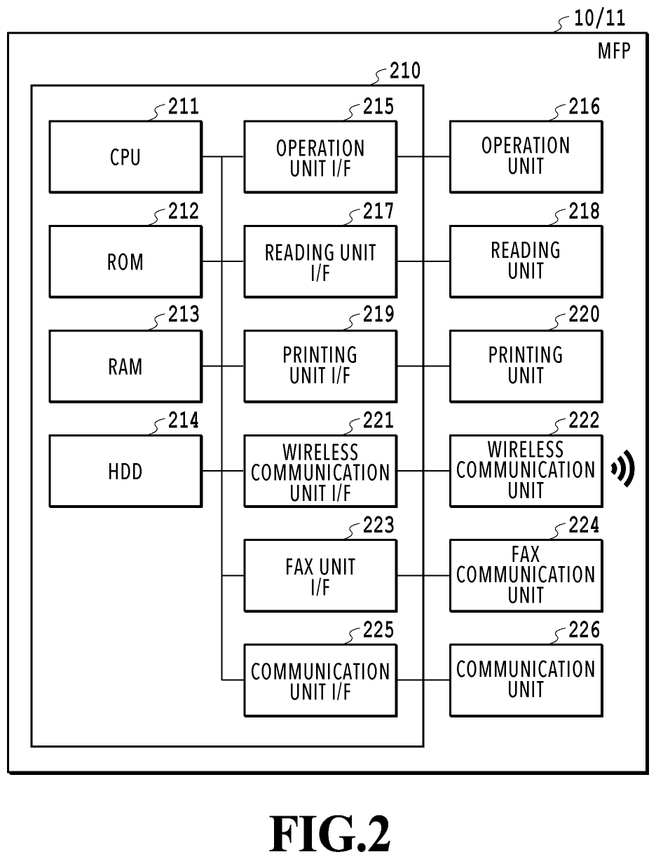

Following the above, with reference to FIG. 2 to FIG. 4, the hardware configuration of each apparatus is explained.

FIG. 2 is a diagram showing one example of the hardware configuration of the MFP 10. A control unit 210 including a CPU 211 controls the operation of the whole MFP 10. The CPU 211 reads control programs stored in a ROM 212 or an HDD 214 onto a RAM 213 and performs various type of control, such as reading control and printing control. The ROM 212 stores control programs that can be executed by the CPU 211. Further, the ROM 212 also stores boot programs, font data and the like. The RAM 213 is a main storage memory and used as a temporary storage area for loading various control programs stored in the ROM 212 and the HDD 214. The HDD 214 stores image data, print data, various programs, various addresses, and various types of setting information. The HDD 214 is a storage medium and an SSD, an eMMC or the like may be used in place of the HDD.

In the MFP 10 of the present embodiment, the one CPU 211 performs each piece of processing shown in a flowchart, to be described later, by using the one memory (RAM 213), but this is not limited. For example, it is also possible to perform each piece of processing by causing a plurality of CPUs, RAMs, ROMs, and HDDs to cooperate with one another. Further, it may also be possible to perform part of the processing by using a hardware circuit, such as an ASIC and an FPGA.

An operation unit I/F (interface) 215 connects an operation unit 216 including a display unit, for example, such as a touch panel, and a hard key, and the control unit 210 to each other. The operation unit 216 displays information to a user, detects an input from a user, and so on. A reading unit I/F 217 connects a reading unit 218 and the control unit 210 to each other. The reading unit (scanner) 218 optically reads an image of a document and the CPU 211 converts the image into image data, such as binary data. The image data generated based on the image read by the reading unit 218 is transmitted to an external device, printed on printing paper, and so on. A printing unit I/F 219 connects a printing unit 220 and the control unit 210 to each other. The CPU 211 transfers the image data (print data) stored in the RAM 213 to the printing unit 220 via the printing unit I/F 219. The printing unit 220 prints an image based on the transferred image data on printing paper fed from a paper feeding cassette.

A wireless communication unit I/F 221 controls a wireless communication unit 222 and wirelessly connects the control unit 210 and external wireless equipment to each other. A configuration may be acceptable in which the user terminals 20 to 22 are used as external wireless equipment. A FAX unit I/F 223 performs connection to the public switched telephone network 80, control of a facsimile communication protocol, and so on, by controlling a facsimile communication modem and NCU comprised by a FAX communication unit 224. A communication unit I/F 225 connects the control unit 210 and the network 70 to each other. Via the communication unit I/F 225, a communication unit 226 transmits image data and various pieces of information to an information processing apparatus on the network 70, receives print data from the information processing apparatus on the network 70 and information on the network 70, and so on. As the method of transmission and reception via the network 70, there is an electronic mail (E mail) or file transmission using a communication protocol, for example, such as FTP, SMB, and WEBDAV. Further, it is also possible to perform transmission and reception of image data and various pieces of setting data via the network 70 by access by HTTP communication from the user terminal 20 and the application server 30.

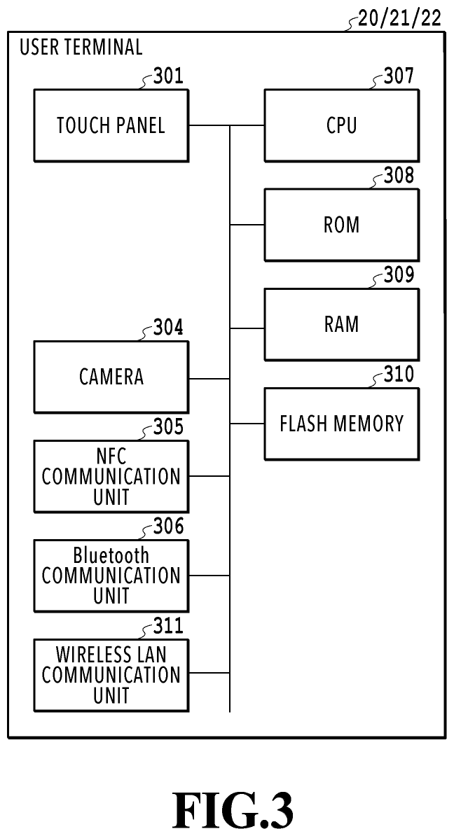

FIG. 3 is a diagram showing one example of the hardware configuration of the user terminal 20. As the user terminal 20 of the present embodiment, the apparatus, such as a smartphone and a tablet PC, is supposed, but the apparatus may be any information processing apparatus capable of connecting to the network 70 by using Wi-Fi communication or the like.

A CPU 307 reads control programs stored in a ROM 308 and performs a variety of pieces of processing for controlling the operation of the user terminal 20. The ROM 308 stores the control programs. A RAM 309 is used as a temporary storage area, such as a main memory and a work area, of the CPU 307. A flash memory 310 stores a variety of pieces of data, such as a photo and an electronic document.

A touch panel 301 can detect the touch operation of a user and displays various screens provided by the OS and an electronic mail transmission application. Further, the touch panel 301 is used for checking information stored in the application server 30. It is possible for a user to input desired operation instructions to the user terminal 20 by inputting the touch operation to the touch panel 301. The user terminal 20 comprises a hardware key, not shown schematically, and it is possible for a user to input operation instructions to the user terminal 20 by using this hardware key. A camera 304 performs image capturing in accordance with image capturing instructions of a user. A photo captured by the camera 304 is stored in a predetermined area of the flash memory 310. Further, by using a program capable of QR code (registered trademark) analysis, it is also possible to obtain information from the QR code read by the camera 304.

It is possible for the user terminal 20 to perform transmission and reception of data with various pieces of peripheral equipment via an NFC (Near Field Communication) communication unit 305, a Bluetooth (registered trademark) communication unit 306, and a wireless LAN communication unit 311. The Bluetooth communication unit 306 of the user terminal 20 may be compatible with Bluetooth Low Energy.

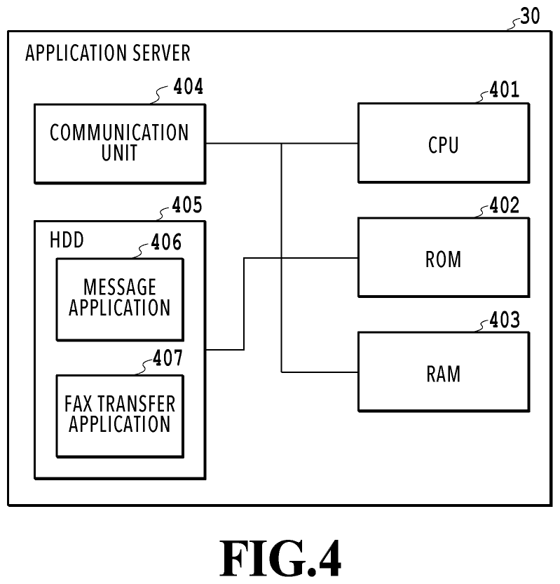

FIG. 4 is a diagram showing one example of the hardware configuration of the application server 30. A CPU 401 performs a variety of pieces of processing for controlling the operation of the message application server 30 by reading control programs stored in a ROM 402 and the message application 406 stored in an HDD 405. The ROM 402 stores the control programs. A RAM 403 is used as a temporary storage area, such as a main memory and a work area, of the CPU 401. A communication unit 404 performs transmission and reception of data with various pieces of equipment, such as the user terminal 20 and the MFP 10, by performing wired communication using Ethernet (registered trademark), or wireless communication, such as Wi-Fi. The HDD 405 stores a variety of pieces of data, such as messages, images, channel information, and applications. In the HDD 405, the message application 406 is installed and the message application 406 operates on the CPU 401. A FAX transfer application 407 is a cooperative application of the message application 406. The FAX transfer application 407 receives registration of notification conditions predefining to which talk room a notification is transferred, receives registration of address book data associating the name of the source of transmission and address information with each other, and so on. Then, the FAX transfer application 407 transmits the received registration information to the MFP 10.

### <Software Configuration of MFP>

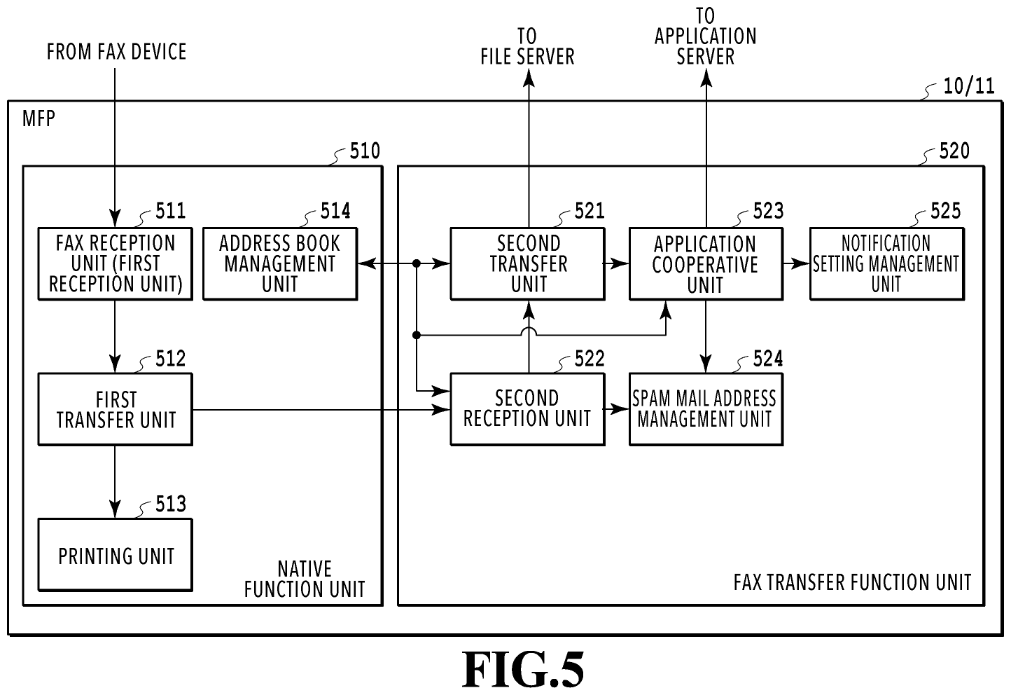

FIG. 5 is a diagram showing one example of the software configuration implementing functions relating to printing of received FAX data and storage to the file server (not shown schematically), and communication with the application server 30 among the functions comprised by the MFP 10. Printing of received FAX data and storage to the file server are implemented by two function units, that is, a native function unit 510, which is a basic function unit, and a FAX transfer function unit 520, which is an additional function unit. In a case of the present embodiment, while each unit included in the native function unit 510 is comprised as a standard unit in the MFP 10, each unit included in the FAX transfer function unit 520 is comprised by an application therefor being additionally installed in the MFP 10. The FAX transfer function unit 520 is implemented by an application based on Java (registered trademark) and it is possible to easily implement addition of a function to the MFP 10. In the MFP 10, another application not shown schematically may be installed further.

### <<Internal Configuration of Native Function Unit>>

A FAX reception unit (first reception unit) 511 receives image data transmitted via the public switched telephone network 80. The FAX reception unit 511 delivers the received image data (FAX data) to a first transfer unit 512 after converting the image data into the PDF format. At this time, the FAX reception unit 511 creates a control file including information on the source of transmission of the FAX data (FAX number of the source of transmission), the date of reception of the FAX data, and the like and delivers the control file to the first transfer unit 512 along with the FAX data. Here, the FAX number of the source of transmission refers to the number obtained by the caller number notification function and the FAX number indicating the caller included in the TSI signal transmitted from the calling side. Alternatively, the FAX number of the source of transmission may be the FAX number of the calling side, which can be obtained by another method.

The first transfer unit 512 transfers the FAX data received from the FAX reception unit 511 in accordance with conditions set in advance. As the transfer destination of the FAX data, it is possible to set a printing unit 513, a file server (not shown schematically), the user terminals 20 to 22 on the network 70 and the like. Here, it is assumed that the setting is performed so that all the FAX data received by the FAX reception unit 511 is transferred once to the FAX transfer function unit 520. The first transfer unit 512 has the FTP client function and transfers FAX data by FTP to a second reception unit 522 having the FTP server function. The control file created by the FAX reception unit 511 is also transferred by FTP to the second reception unit 522 along with the FAX data.

The printing unit 513 forms an image on a sheet and outputs the sheet in accordance with the FAX data received from the first transfer unit 512 and the like. An address book management unit 514 registers the name representing each source of transmission, which is designated by a user of the MFP 10, and address information on each source of transmission in association with each other and manages them as address book data. Details of the address book data managed by the address book management unit 514 will be described later.

### <<Internal Configuration of FAX Transfer Function Unit>>

The second reception unit 522 receives FAX data internally transferred from the first transfer unit 512 and delivers the FAX data to a second transfer unit 521. The second transfer unit 521 transfers (transmits) the FAX data to, for example, a file server not shown schematically, in accordance with transfer setting, to be described later. For the transfer here, it is possible to use SMB, WebDAV and the like, in addition to FTP. Further, the second transfer unit 521 is permitted to access the address book management unit 514 and obtains a registered name, to be described later.

An application cooperative unit 523 performs processing relating to a transfer notification of received FAX data in cooperation with the message application 406 described previously.

A spam address management unit 524 performs management of a spam FAX number, to be described later. FAX data received from the FAX number managed by the spam address management unit 524 is not necessary for a user. Because of this, by managing the FAX number of a specific source of transmission as a spam address, in a case where FAX data is transferred to the file server, it is made possible to transfer the FAX data from the FAX number to another folder other than the folder for the normal FAX, or not to give a notification.

A notification setting management unit 525 manages conditions (notification conditions), such as which talk room is notified of the transfer of the received FAX data and which user you are going to notify (in the following, this is described as “which user is mentioned”) at this time, in association with the FAX number of the source of transmission of the FAX data.

In the present embodiment, the configuration is explained as one in which the address book management unit 514 and the FAX transfer function unit 520 are included in the MFP 10, but the configuration may be one in which they are included in the application server 30 or another server not shown schematically.

### <Transfer Setting Processing>

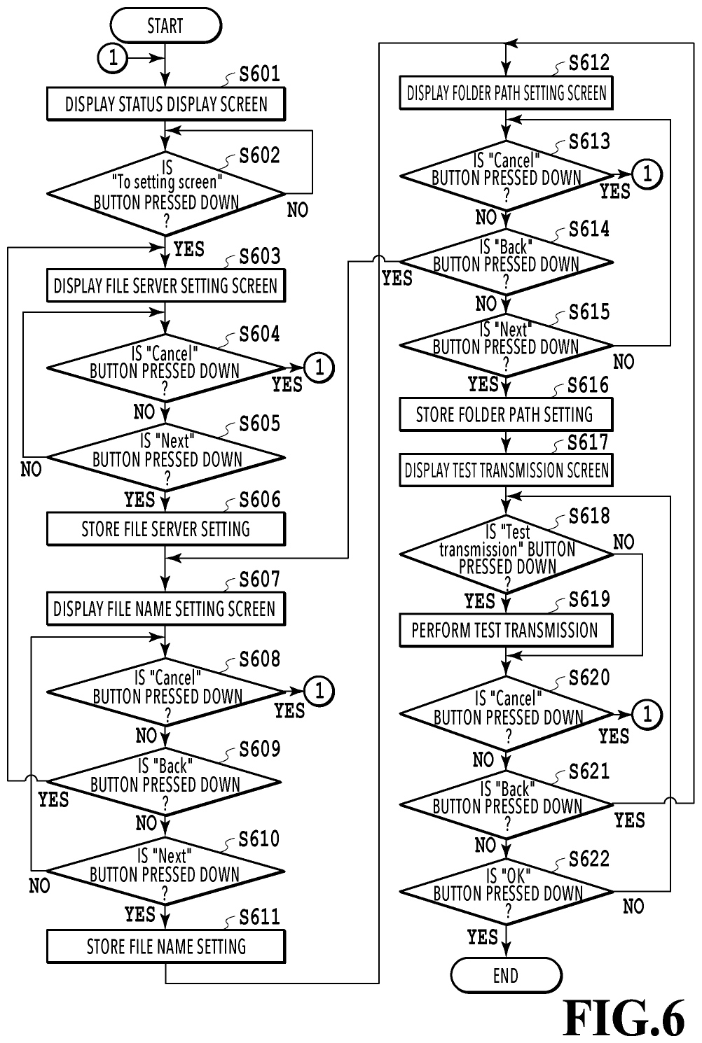

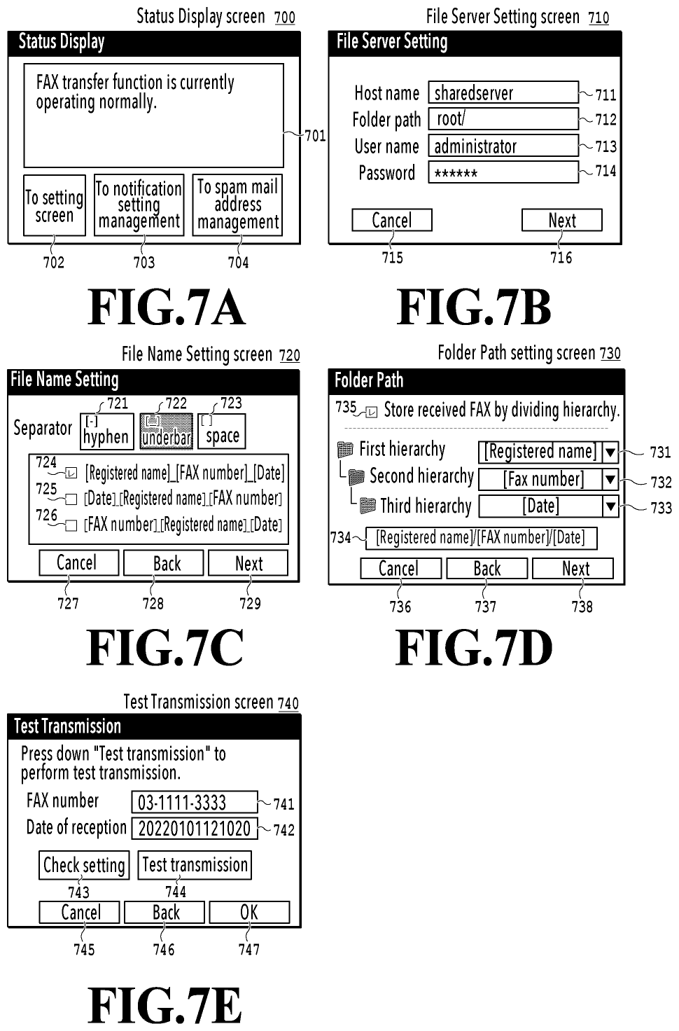

FIG. 6 is a flowchart showing a flow of setting processing for transferring received FAX data. The series of processing is implemented by the CPU 211 loading a control program stored in the HDD 214 onto the RAM 213 and executing the control program. In the following, the flowchart in FIG. 6 is explained with reference to one example of each transfer setting UI screen displayed on the operation unit 216 shown in FIG. 7A to FIG. 7E. In the following explanation, a symbol “S” means a step.

First, at S601, a status display screen is displayed on the operation unit 216. FIG. 7A is a diagram showing one example of the status display screen. In a status display area 701 on a Status Display screen 700, a message indicating the current operation status of the FAX transfer function unit 520 is displayed. In the example in FIG. 7A, a message representing that the FAX transfer function unit 520 is currently operating normally is displayed. For example, in a case where transfer of FAX data to a file server (not shown schematically) fails, or in a case where the FAX transfer function unit 520 is in the state of not operating normally, a message to that effect is displayed in the status display area 701. Within the Status Display screen 700, it may also be possible to further provide an operation button for updating the display contents in the status display area 701.

At S602, whether or not a “To setting screen” button 702 on the Status Display screen 700 is pressed down is determined. Here, the standby state continues until the “To setting screen” button 702 is pressed down and in a case where it is determined that the “To setting screen” button 702 is pressed down, the processing advances to S603. Processing in a case where a “To notification setting management” button 703 and a “To spam address management” button 704 within the Status Display screen 700 are pressed down is not included in this flow, but this processing will be described later. On the Status Display screen 700 shown in FIG. 7A, the three buttons (“To setting screen” button 702, “To notification setting management” button 703, and “To spam address management” button 704) are provided. In addition to these buttons, for example, buttons for causing the screen to make a transition directly to each setting screen in FIG. 7B to FIG. 7E, to be described later, may be provided.

At S603, a file server setting screen is displayed on the operation unit 216. FIG. 7B is a diagram showing one example of the file server setting screen. A user of the MFP 10 inputs information for identifying a file server and information for accessing the file server via a File Server Setting screen 710. Specifically, to a Host name input field 711, the host name (or IP address) of the file server is input. To a Folder path input field 712, the starting point of a folder path for identifying the storage destination of the received FAX data is input. To a User name input field 713 and a Password input field 714, authentication information (user name and password) necessary for logging in to the file server is input.

At S604, whether or not a “Cancel” button 715 within the File Server Setting screen 710 is pressed down is determined. In a case where the “Cancel” button 715 is pressed down, the processing returns to S601 and the Status Display screen 700 is displayed. In a case where the “Cancel” button 715 is not pressed down, the processing advances to S605 and whether or not a “Next” button 716 is pressed down is determined. Then, in a case where the “Next” button 716 is pressed down, the processing advances to S606 and in a case where the “Next” button 716 is not pressed down, the processing returns to S604.

At S606, the contents of the file server setting input to the input fields 711 to 714 within the File Server Setting screen 710 are stored in the HDD 214.

At S607, a file name setting screen is displayed on the operation unit 216. FIG. 7C is a diagram showing one example of a file name setting screen. A user of the MFP 10 designates setting rules of a file name that is set to FAX data to be transferred via a File Name Setting screen 720. It is possible to set a file name combining three types of information of [Registered name], [FAX number], and [Date] to FAX data to be transferred to the file server by the FAX transfer function unit 520. [Registered name] is a name registered in advance in an address book in association with the FAX number of the source of transmission of FAX data. [FAX number] is the FAX number of the source of transmission of FAX data. [Date] is the date of reception of FAX data. It is possible for a user of the MFP 10 to select a separator (delimiter) for separating the three types of information described above by using operation buttons 721 to 723. In a case where the operation button 721 is pressed down, [-] (hyphen) is selected. In a case where the operation button 722 is pressed down, [_] (underbar) is selected. In a case where the operation button 723 is pressed down, [ ] (space) is selected. In the screen example in FIG. 7C, the portion of [_] (underbar) is highlighted, meaning that it is selected by a user. Further, it is possible for a user of the MFP 10 to designate an arrangement order of the three types of information described above by using checkboxes 724 to 726. Here, in a case where the checkbox 724 is checked, the file name is set, which is the combination of the above-described three types of information in the arrangement order of [Registered name], [FAX number], and [Date]. For example, in a case where the registered name is “ABC Corp.” the FAX number is “03-1111-3333”, and the date is “Jan. 1, 2022 12:15:10”, a file name “ABC Corp._0311113333_112022121510.pdf” is set. Similarly, in a case where the checkbox 725 is checked, the file name is set, which is the combination of the three types of information in the arrangement order of [Date], [Registered name], and [FAX number]. Further, in a case where the checkbox 726 is checked, the file name is set, which is the combination of the three types of information in the arrangement order of [FAX number], [Registered name], and [Date]. Here, all the arrangement orders are not taken as candidates (only part of arrangement orders are taken as candidates), but it may also be possible to display all the arrangement orders as candidates.

At S608, whether or not a “Cancel” button 727 within the File Name Setting screen 720 is pressed down is determined. In a case where the “Cancel” button 727 is pressed down, the processing returns to S601 and the Status Display screen 700 is displayed. In a case where the “Cancel” button 727 is not pressed down, the processing advances to S609 and whether or not a “Back” button 728 is pressed down is determined. In a case where the “Back” button 728 is pressed down, the processing returns to S603 and the File Server Setting screen 710 is displayed. In a case where the “Back” button 728 is not pressed down, the processing advances to S610 and whether or not a “Next” button 729 is pressed down is determined. Then, in a case where the “Next” button 729 is pressed down, the processing advances to S611. In a case where the “Next” button 729 is not pressed down, the processing returns to S608.

At S611, the contents of the setting rules of a file name, which are designated via the File Name Setting screen 720, are stored in the HDD 214.

At S612 that follows, a Folder Path setting screen 730 is displayed on the operation unit 216. FIG. 7D is a diagram showing one example of a folder path setting screen. A user of the MFP 10 designates setting rules of a folder path for identifying a folder, which is the storage destination of FAX data, via the Folder Path setting screen 730 shown in FIG. 7D. Here, in a case where a checkbox 735 is checked, FAX data is stored in folders designated in selection fields 731 to 733. On the other hand, in a case where the checkbox 735 is not checked, FAX data is stored within the folder designated in the Folder path input field 712 on the File Server Setting screen 710. In the selection field 731, the type of information used as a folder name of the first hierarchy (the highest hierarchy of the three hierarchies) is designated. A user of the MFP 10 selects the type of information from the candidates [Registered name], [Fax number], and [Date] presented in a pulldown menu. In the selection field 732, the type of information used as a folder name of the second hierarchy (the intermediate hierarchy of the three hierarchies) is designated. A user of the MFP 10 selects the type of information from the candidates [Registered name], [Fax number], and [Date] presented in a pulldown menu as in the case of the first hierarchy. In the selection field 733, the type of information used as a folder name of the third hierarchy (the lowest hierarchy of the three hierarchies) is designated. A user of the MFP 10 selects the type of information from the candidates [Registered name], [Fax number], and [Date] presented in a pulldown menu as in the case of the first hierarchy. It is also possible not to select any type in the selection fields 731 to 733 and in this case, FAX data is stored within the folder designated in the Folder path input field 712. In a display field 734, the arrangement order of each type of information in accordance with the selection for each hierarchy in the selection fields 731 to 733 is displayed. In the example in FIG. 7D, it can be seen that the folder name of the first hierarchy is [Registered name], the folder name of the second hierarchy is [Fax number], and the folder name of the third hierarchy is [Date]. By attaching the folder path indicated in the display field 734 to the end of the character string representing the folder name designated in the Folder path input field 712 on the File Server Setting screen 710, a formal folder path is completed. For example, in a case where the registered name is “ABC Corp.”, the FAX number is “03-1111-3333”, and the date is “Oct. 1, 2022”, a folder path “root/ABC Corp./0311113333/1012022” is set.

At S613, whether or not a “Cancel” button 736 within the Folder Path setting screen 730 is pressed down is determined. In a case where the “Cancel” button 736 is pressed down, the processing returns to S601 and the Status Display screen 700 is displayed. In a case where the “Cancel” button 736 is not pressed down, the processing advances to S614 and whether or not a “Back” button 737 is pressed down is determined. In a case where the “Back” button 737 is pressed down, the processing returns to S607 and the File Name Setting screen 720 is displayed. In a case where the “Back” button 737 is not pressed down, the processing advances to S615 and whether a “Next” button 738 is pressed down is determined. Then, in a case where the “Next” button 738 is pressed down, the processing advance to S616. In a case where the “Next” button 738 is not pressed down, the processing returns to S613.

At S616, the contents of the setting rules of a folder path, which are designated via the Folder Path setting screen 730, are stored in the HDD 214.

At S617 that follows, a test transmission screen is displayed on the operation unit 216. FIG. 7E is a diagram showing one example of a test transmission screen. It is possible for a user of the MFP 10 to perform test transmission to the file server via a Test Transmission screen 740 To a FAX number input field 741 within the Test Transmission screen 740, an arbitrary FAX number of the source of transmission used for test transmission is input. Further, to a Date of reception input field 742, an arbitrary date of reception used for test transmission is input. By pressing down a “Check setting” button 743, with which file name and in which folder FAX data is stored is displayed based on the contents of the setting performed in the FAX number input field 741 and the Date of reception input field 742 and on each of the screens in FIG. 7B to FIG. 7D described previously. Due to this, it is possible for a user to check the contents of each setting.

At S618, whether or not a “Test transmission” button 744 within the Test Transmission screen 740 is pressed down is determined. In a case where the “Test transmission” button 744 is pressed down, the processing advances to S619 and in a case where the “Test transmission” button 744 is not pressed down, the processing advances to S620.

At S619, test transmission is performed based on the contents input to the FAX number input field 741 and the Date of reception input field 742 and the contents of the setting performed on each screen in FIG. 7B to FIG. 7D. In the test transmission, image data for test transmission stored in advance within the FAX transfer function unit 520 (within HDD 214) is transmitted to the file server actually. It is possible for a user to check that FAX data is stored in the folder of the file server normally by performing the test transmission. It may also be possible to display a screen showing the results of the test transmission after performing the test transmission.

At S620, whether or not a “Cancel” button 745 within the Test Transmission screen 740 is pressed down is determined. In a case where the “Cancel” button 745 is pressed down, the processing returns to S601 and the Status Display screen 700 is displayed. In a case where the “Cancel” button 745 is not pressed down, the processing advances to S621 and whether or not a “Back” button 746 is pressed down is determined. Then, in a case where the “Back” button 746 is pressed down, the processing returns to S612 and the Folder Path setting screen 730 is displayed. In a case where the “Back” button 746 is not pressed down, the processing advances to S622 and whether or not an “OK” button 747 is pressed down is determined. Then, in a case where the “OK” button 747 is not pressed down, the processing returns to S618. In a case where the “OK” button 747 is pressed down, this processing is terminated.

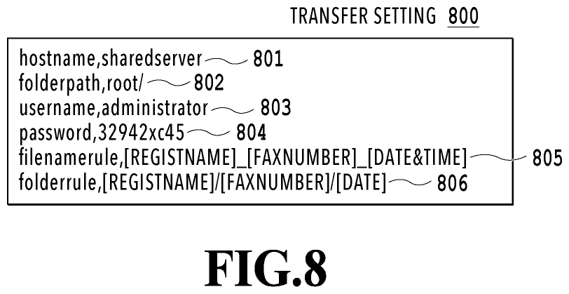

The above is the contents of the setting processing for transferring received FAX data. FIG. 8 is a diagram showing one example of “transfer setting” that is set in accordance with the flowchart in FIG. 6 described above. In a row 801 of transfer setting 800 shown in FIG. 8, the host name of the file server input to the Host name input field 711 on the File Server Setting screen 710 is described. In a row 802, the starting point of the folder path input to the Folder path input field 712 on the File Server Setting screen 710 is described. In a row 803, the user name for logging in to the file server, which is input to the User name input field 713 on the File Server Setting screen 710 is described. In a row 804, the password for logging in to the file server 102, which is input to the Password input field 714 on the File Server Setting screen 710 is described. In a row 805, the setting rules of the file name set on the File Name Setting screen 720 are described. In the example in FIG. 8, the file name is set using the separator of [_] (underbar) in the arrangement order of [Registered name], [FAX number], and [Date]. In a row 806, the setting rules of the folder path set on the Folder Path setting screen 730 are described. The information such as this is stored in the HDD 214 as “transfer setting” in the format, such as CSV and XML.

### <Address Book>

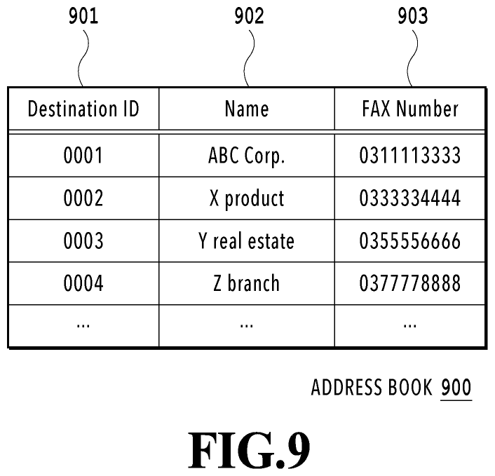

Next, address book data managed by the address book management unit 514 of the native function unit 510 is explained. FIG. 9 is a diagram showing one example of address book data. An address book 900 shown in FIG. 9 includes three pieces of item data of Destination ID 901, Name 902, and FAX Number 903. Destination ID 901 is an ID capable of uniquely identifying each registered destination. Name 902 is a name of each registered destination. FAX Number 903 is a FAX number of each registered destination. In a case where image data read by the reading unit 218 is transmitted by facsimile from the MFP 10 via the public switched telephone network 80, by referring to the address book data as shown in FIG. 9, it is possible to save the time and effort to designate the destination. In the address book data, not only the destination of facsimile transmission but also the destination of e-mail, the destination of file transmission (FTP, SMB, WebDAV) and the like may be registered.

### <Transfer Notification Setting Processing>

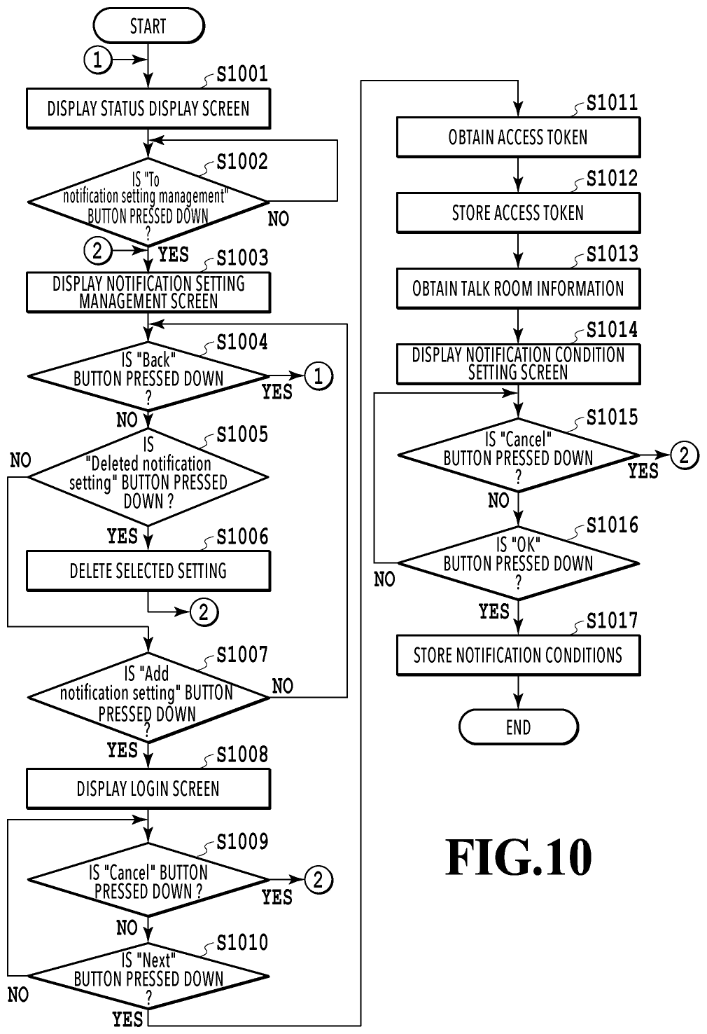

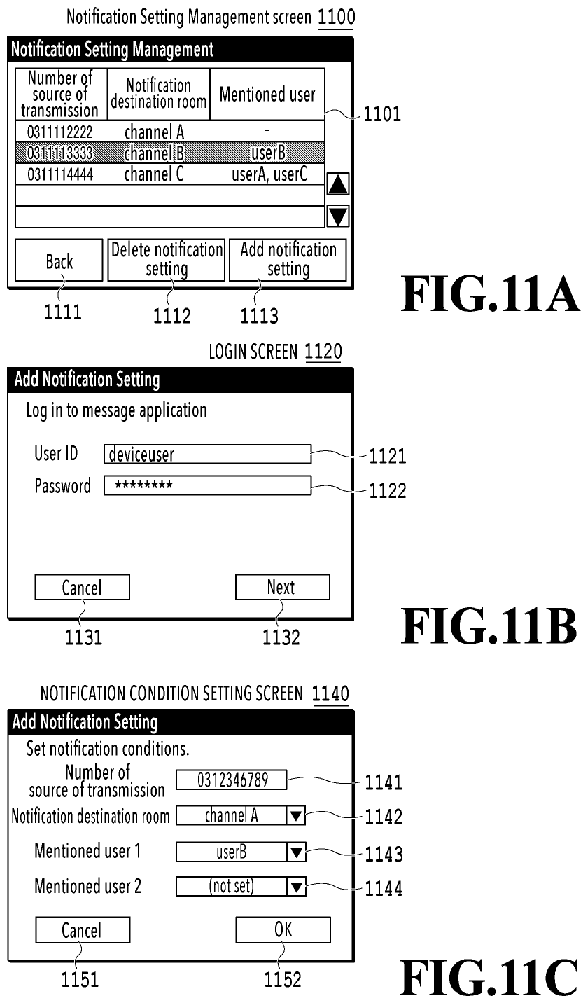

FIG. 10 is a flowchart showing a flow of processing to set conditions for giving a notification to the talk room after transferring received FAX data. The series of processing is implemented by the CPU 211 loading a control program stored in the HDD 214 onto the RAM 213 and executing the control program. In the following, with reference to one example of a notification setting UI screen displayed on the operation unit 216, which is shown in FIG. 11A to FIG. 11C, the flowchart in FIG. 10 is explained. In the following explanation, a symbol “S” means a step.

First, at S1001, a status display screen is displayed on the operation unit 216. This is the same as S601 in the flowchart in FIG. 6 described previously, and therefore, explanation is omitted.

At S1002, whether or not the “To notification setting management” button 703 on the Status Display screen 700 is pressed down is determined. In a case where the “To notification setting management” button 703 is determined to be pressed down, the processing advances to S1003.

At S1003, a notification setting management screen is displayed on the operation unit 216. FIG. 11A is a diagram showing one example of a notification setting management screen. It is possible for a user of the MFP 10 to perform addition or deletion of notification setting via a Notification Setting Management screen 1100 shown in FIG. 11A. In a list field 1101 within the Notification Setting Management screen 1100, the contents of notification setting list data stored in the HDD 214 are displayed. In the screen example in FIG. 11A, the screen is in the state where three notification settings are registered, each notification setting including three items of “Number of source of transmission”, “Notification destination room”, and “Mentioned user”. Here, the second notification setting from the top in the list field 1011 is highlighted and this indicates that the second notification setting is selected by a user.

At S1004, whether or not a “Back” button 1111 within the Notification Setting Management screen 1100 is pressed down is determined. In a case where the “Back” button 1111 is pressed down, the processing returns to S1001 and the Status Display screen 700 is displayed. In a case where the “Back” button 1111 is not pressed down, the processing advances to S1005 and whether or not a “Delete notification setting” button 1112 is pressed down is determined. In a case where the “Delete notification setting” button 1112 is pressed down, the processing advances to S1006 and the notification setting selected in the list field 1011 is deleted and the processing returns to S1003. In a case where the “Delete notification setting” button 1112 is not pressed down, the processing advances to S1007 and whether or not an “Add notification setting” button 1113 is pressed down is determined. In a case where the “Add notification setting” button 1113 is pressed down, the processing advances to S1008. In a case where the “Add notification setting” button 1113 is not pressed down, the processing returns to S1004.

At S1008, a login screen for logging in to the message application 406 provided by the application server 30 is displayed on the operation unit 216. FIG. 11B is a diagram showing one example of a login screen. A user of the MFP 10 inputs information for accessing the message application 406 via a login screen 1120 shown in FIG. 11B. Specifically, a user inputs authentication information (user ID and password) necessary for logging in to the message application 406 to a User ID input field 1121 and a Password input field 1122.

At S1009, whether or not a “Cancel” button 1131 within the login screen 1120 is pressed down is determined. In a case where the “Cancel” button 1131 is pressed down, the processing returns to S1003 and the Notification Setting Management screen 1100 is displayed. In a case where the “Cancel” button 1131 is not pressed down, the processing advances to S1010 and whether or not a “Next” button 1132 is pressed down is determined. Then, in a case where the “Next” button 1132 is pressed down, the processing advances to S1011. In a case where the “Next” button 1132 is not pressed down, the processing returns to S1009.

At S1011, by using the user ID and password input on the login screen 1120, an access token is obtained from the management server 40. In a case where obtaining an access token fails, an error screen (not shown schematically) is displayed and the processing may return to the processing at S1008. At next S1012, the access token obtained by the processing at S1011 is stored in the HDD 214.

At S1013, by using the access token obtained at S1011, talk room information is obtained from the management server 40. The talk room information refers to, for example, information on the channel to which the login user belongs, information on the user belonging to the same organization as that of the login user, and the like.

At S1014, on the operation unit 216, a notification condition setting screen is displayed. FIG. 11C is a diagram showing one example of a notification condition setting screen. It is possible for a user of the MFP 10 to designate details of a notification condition to be added via a notification condition setting screen 1140 shown in FIG. 11C. To a Number of source of transmission input field 1141 within the notification condition setting screen 1140, the FAX number of the source of transmission is, which is the target to which a notification is given after FAX data is transferred. Then, in selection fields 1142 to 1144, based on the talk room information obtained at S1013, from candidates presented in a pulldown menu, a talk room, which is the notification destination, and a user who is mentioned at the time of notification are designated. In the selection field 1142, from among candidates of the talk room (channel) presented in a pulldown menu, a talk room is designated, which is the notification destination. In the selection field 1143 and the selection field 1144, from among candidate users presented in a pulldown menu, a user is designated who is desired to be mentioned in a case where a notification is given to the talk room designated in the selection field 1142. It is also possible not to select any user in the selection field 1143 and selection field 1144 and in that case, no user exists who is mentioned at the time of notification. On the notification condition setting screen 1140 in FIG. 11C, “0312346789” is designated as “Number of source of transmission”, “channel A” is designated as “Notification destination room”, and “user B” is designated as “Mentioned user 1”, respectively, and nothing is designated as “Mentioned user 2”. With this notification setting, in a case where FAX is received from the FAX number “0312346789”, after the FAX is transferred to the file server, a notification to the effect that the FAX is transferred to the talk room of “channel A” by mentioning the user of “user B” is given. In the example of the notification condition setting screen 1140, up to two mentioned users can be designated, but a screen configuration on which two or more mentioned users can be designated may be acceptable. Further, it may also be possible to cause the screen to have a notification test function so that it is possible to check in advance whether a notification is given as intended.

At S1015, whether or not a “Cancel” button 1151 within the notification condition setting screen 1140 is pressed down is determined. In a case where the “Cancel” button 1151 is pressed down, the processing returns to S1003 and the Notification Setting Management screen 1100 is displayed. In a case where the “Cancel” button 1151 is not pressed down, the processing advances to S1016 and whether or not an “OK” button 1152 is pressed down is determined. Then, in a case where the “OK” button 1152 is pressed down, the processing advances to S1017. In a case where the “OK” button 1152 is not pressed down, the processing returns to S1015.

At S1017, the contents designated via the notification condition setting screen 1140 are stored in the notification setting list data as new “notification setting” by the notification setting management unit 525 and stored in the HDD 214.

The above is the contents of the setting processing for giving a notification to the effect that FAX data is transferred. The processing at S1008 to S1012 is processing that is performed for obtaining an access token from the management server 40. Because of this, in a case where the access token stored in the processing at S1012 exists, it may also be possible to skip the processing at S1008 to S1012 and perform the processing at S1013 by using the stored access token.

### <Spam Address Setting Processing>

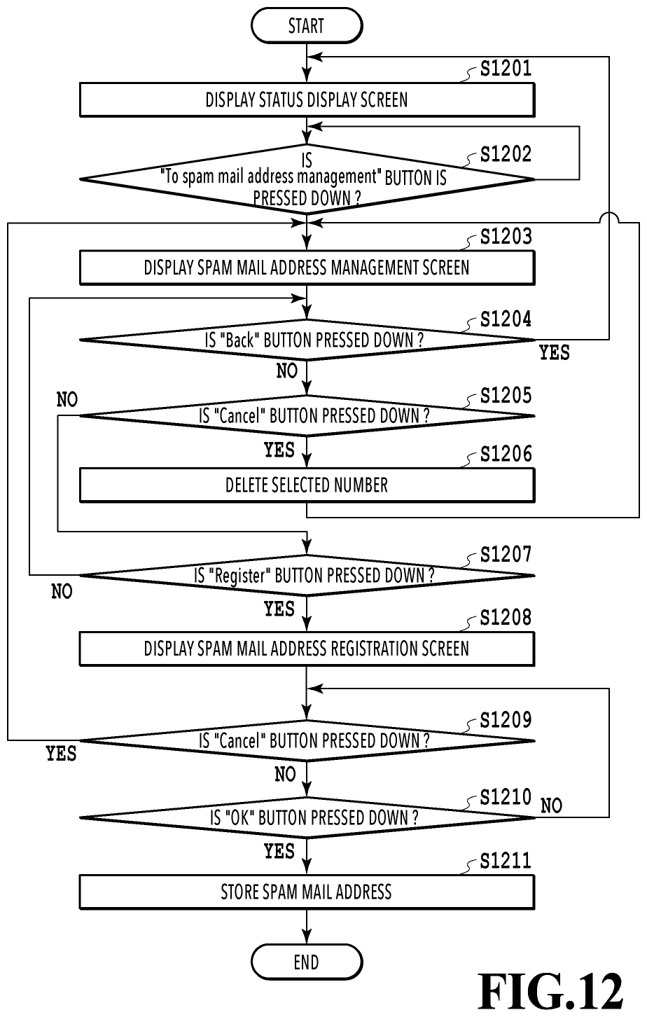

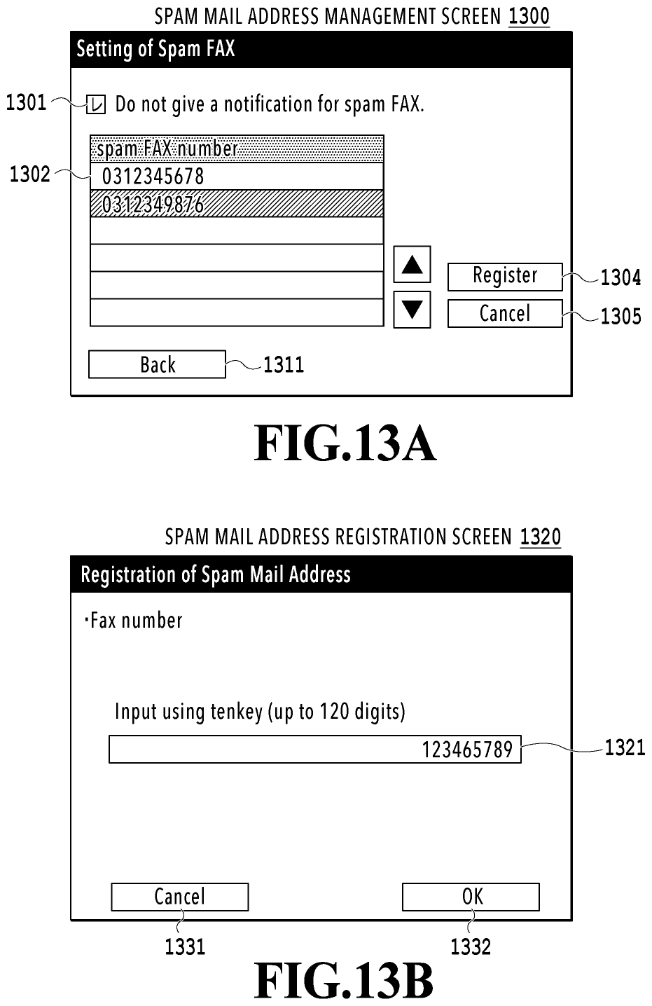

FIG. 12 is a flowchart showing a flow of setting processing relating to a spam address in the MFP 10. The series of processing is implemented by the CPU 211 loading a control program stored in the HDD 214 onto the RAM 213 and executing the control program. In the following, with reference to one example of a spam address setting screen displayed on the operation unit 216 shown in FIG. 13A and FIG. 13B, the flowchart in FIG. 12 is explained. In the following explanation, a symbol “S” means a step.

First, at S1201, the Status Display screen 700 shown in FIG. 7A is displayed on the operation unit 216. This is the same as S601 in the flowchart in FIG. 6 described previously, and therefore, explanation is omitted.

At S1202, whether or not the “To spam address management” button 704 on the Status Display screen 700 is pressed down is determined. In a case where the “To spam address management” button 704 is determined to be pressed down, the processing advances to S1203.

At S1203, a spam address management screen is displayed on the operation unit 216. FIG. 13A is a diagram showing one example of a spam address management screen. It is possible for a user of the MFP 10 to register and delete the FAX number of the received FAX annoying to the user him/herself via a spam address management screen 1300 shown in FIG. 13A. For example, by registering the FAX number of a company or the like transmitting FAX of sales information having nothing to do with the business of the user him/herself as a spam FAX number, it is made possible to transfer such a spam FAX to a dedicated folder, such as a spam FAX folder. In a case where a check box 1301 within the spam address management screen 1300 is checked, control is performed so that no notification is given after transfer for the FAX data whose source of transmission is the FAX number registered as the spam FAX number. In a list field 1302 within the spam address management screen 1300, the contents of the spam address list data stored in the HDD 214 are displayed. The spam address list is a list storing specific FAX numbers as spam FAX numbers. The screen example in FIG. 13A is in the state where two FAX numbers “0312345678” and “0312349876” are displayed in a list as spam FAX numbers and the second FAX number is highlighted and this indicates that the second FAX number is selected by a user.

At S1204, whether or not a “Back” button 1311 within the spam address management screen 1300 is pressed down is determined. In a case where the “Back” button 1311 is pressed down, the processing returns to S1201 and the Status Display screen 700 is displayed. In a case where the “Back” button 1311 is not pressed down, the processing advances to S1205 and whether or not a “Cancel” button 1305 is pressed down is determined. In a case where the “Cancel” button 1305 is pressed down, the processing advances to S1206 and the FAX number selected in the list field 1302 currently displayed is deleted and the processing returns to S1203. In a case where the “Cancel” button 1305 is not pressed down, the processing advances to S1207 and whether or not a “Register” button 1304 is pressed down is determined. In a case where the “Register” button 1304 is pressed down, the processing advances to S1208. In a case where the “Register” button 1304 is not pressed down, the processing returns to S1204.

At S1208, a spam address registration screen for adding a spam FAX number is displayed on the operation unit 216. FIG. 13B is a diagram showing one example of a spam address registration screen. A user of the FMP 10 designates the FAX number the user desires to add as a spam FAX number via a spam address registration screen 1320 shown in FIG. 13B. Specifically, the user inputs a new FAX number to be taken as the target of additional registration to a number input field 1321 within the spam address registration screen 1320.

At S1209 whether or not a “Cancel” button 1331 within the spam address registration screen 1320 is pressed down is determined. In a case where the “Cancel” button 1331 is pressed down, the processing returns to S1203 and the spam address management screen 1300 is displayed. In a case where the “Cancel” button 1331 is not pressed down, the processing advances to S1210 and whether or not an “OK” button 1332 is pressed down is determined. Then, in a case where the “OK” button 1332 is pressed down, the processing advances to S1211. In a case where the “OK” button 1332 is not pressed down, the processing returns to S1209.

At S1211, the FAX number input to the number input field 1321 within the spam address registration screen 1320 is stored in the spam address list as a new spam FAX number by the spam address management unit 524 and stored in the HDD 214.

### <Transfer/Notification Processing>

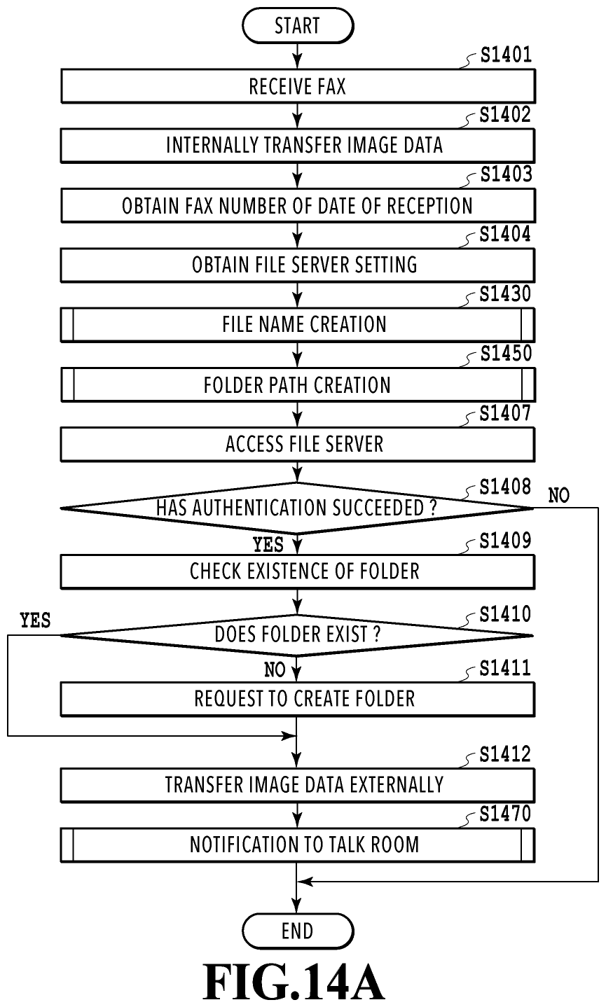

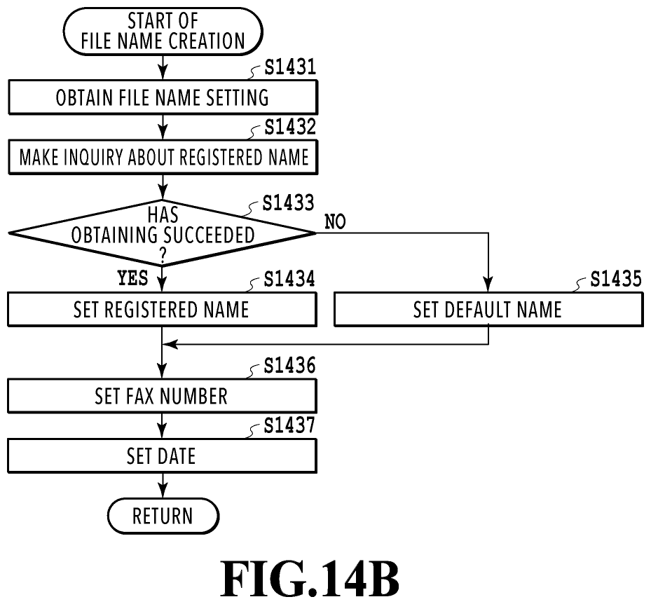

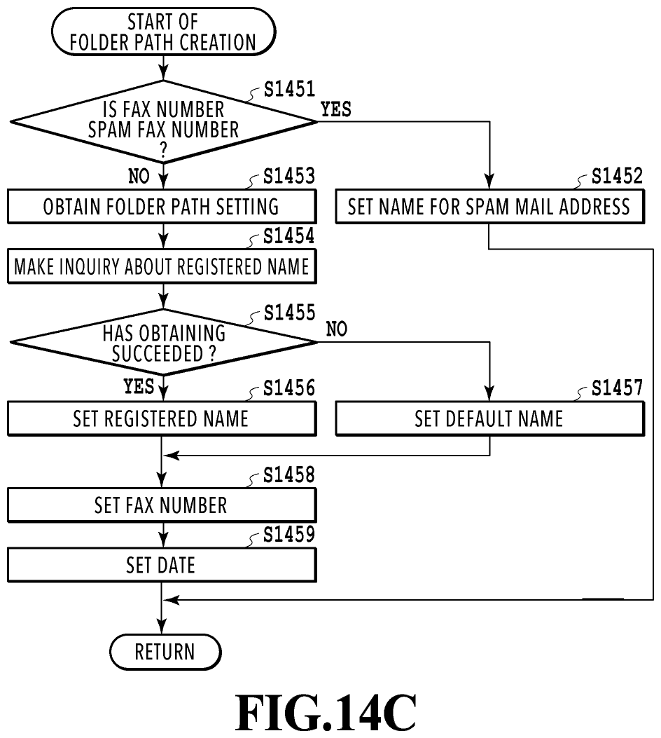

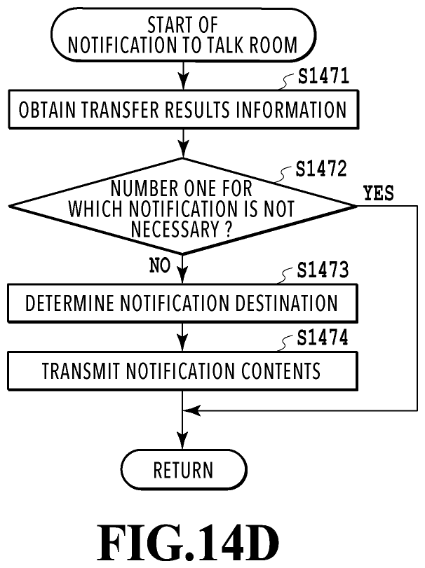

FIG. 14A to FIG. 14D are flowcharts showing flows of transfer processing and transfer/notification processing of received FAX data. The series of processing is implemented by the CPU 211 loading a control program stored in the HDD 214 onto the RAM 213 and executing the control program. In the following, the flowcharts in FIG. 14 to FIG. 14D are explained. In the following explanation, a symbol “S” means a step.

At S1401, by the FAX reception unit 511, image data (FAX data) sent from a facsimile device (not shown schematically) connected to the public switched telephone network 80 is received. The received FAX data is sent to the first transfer unit 512.

At S1402, the FAX data received at S1401 is internally transferred by FTP to the second reception unit 522 of the FAX transfer function unit 520 by the first transfer unit 512. The internally transferred FAX data is further delivered to the second transfer unit 521

At S1403, in the second transfer unit 521, the FAX number of the source of transmission and the date of reception are obtained from the control file internally transferred along with the FAX data.

At S1404, in the second transfer unit 521, the “transfer setting” described previously is referred to and the contents of the file server setting are obtained.

At S1430, in the second transfer unit 521, a file name for the FAX data received at S1401 is created. Here, details of file name creation processing are explained with reference to another flowchart shown in FIG. 14B.

### <<File Name Creation Processing>>

At S1431, the contents of the file name setting included in the transfer setting are obtained.

At S1432, based on the FAX number of the source of transmission obtained at S1403, processing to make an inquiry to the address book management unit 514 about the name registered in association with the FAX number is performed.

At S1433, whether or not the obtaining of the registered name from the address book management unit 514 has succeeded is determined. In a case where the obtaining of the registered name has succeeded, the processing advances to S1434. On the other hand, in a case where the obtaining of the registered name has failed (for example, the FAX number of the source of transmission is not registered in the address book), the processing advances to S1435.

At S1434, the obtained registered name is set as part of the file name.

At S1435, a default name is set as part of the file name. Here, the default name is a character string, for example, such as “Not Applicable”.

At S1436, the FAX number of the source of transmission obtained at S1403 is set as part of the file name.

At S1437, the date of reception obtained at S1403 is set as part of the file name.

The above is the contents of the file name creation processing (S1430). In a case where the file name creation processing is completed, the processing advances to S1450.

At S1450, in the second transfer unit 521, a folder path for identifying the storage destination of the FAX data received at S1401 is created. Here, details of folder path creation processing are explained with reference to anther flowchart shown in FIG. 14C.

### <<Folder Path Creation Processing>>

At S1451, an inquiry about whether the FAX number of the source of transmission obtained at S1403 is a spam FAX number is made to the spam address management unit 524. In a case where the results of the inquiry indicate that the obtained FAX number is a spam FAX number, the processing advances to S1452 and a name for a spam address is set as part of the folder path. Then, the processing at S1450 is terminated. Here, the name for a spam address is, a character string, for example, such as “_unnecessary FAX document”. On the other hand, in a case where the results of the inquiry indicate that the obtained FAX number is not a spam FAX number, the processing advances to S1453.

At S1453, the contents of the folder path setting included in the transfer setting area obtained.

At S1454, based on the FAX number of the source of transmission obtained at S1403, processing to make an inquiry to the address book management unit 514 about the name registered in association with the FAX number is performed. It may also be possible to omit this step by storing in advance the registered name obtained at S1432 of the file name creation processing described previously.

At S1455, whether or not the obtaining of the registered name from the address book management unit 514 has succeeded is determined. In a case where the obtaining of the registered name has succeeded, the processing advances to S1456. On the other hand in a case where the obtaining of the registered name has failed (for example, the FAX number of the source of transmission is not registered in the address book), the processing advances to S1457.

At S1456, the obtained registered name is set as part of the folder path.

At S1457, a default name is set as part of the folder path. Here, the default name is a character string, for example, such as “Not Applicable”.

At S1458, the FAX number of the source of transmission obtained at S1403 is set as part of the folder path.

At S1459, the date of reception obtained at S1403 is set as part of the folder path.

The above is the contents of the folder path creation processing (S1450). In a case where the folder path creation processing is completed, the processing advances to S1407.

At S1407, the second transfer unit 521 accesses the file server (not shown schematically). Then, the second transfer unit 521 transmits the user name and the password included in the file server setting obtained at S1404 to the file server and receives the results of the authentication by the file server.

At S1408, in the second transfer unit 521, whether or not the received authentication results indicate successful authentication (successful login to the file server) is determined. In a case of successful authentication, the processing advances to S1409 and in a case where the authentication has failed, the present processing is terminated.

At S1409, the second transfer unit 521 makes an inquiry to the file server about whether or not the folder indicated by the folder path created at S1450 exists.

At S1410, in accordance with the inquiry results, the next processing is allocated. Specifically, in a case where the inquiry results indicate that the folder that is identified by the folder path created at S1450 does not exist, the processing advances to S1411 and in a case where the inquiry results indicate that the folder exists, the processing advances to S1412.

At S1411, the second transfer unit 521 requests the file server to create the folder indicated by the folder path created at S1450.

At S1412, the second transfer unit 521 transfers FAX data to the file server. In the file server having received the FAX data, processing to store the FAX data to which the file name created at S1430 is attached in the folder indicated by the folder path created at S1450 is performed.

The processing up to this point is the flow of the processing until the FAX data received from an external facsimile device is transferred to the file server. The processing at next S1470 is processing (transfer notification processing) to notify the talk room that the FAX data has been transferred to and stored in the file server in the application cooperative unit 523. Here, details of the transfer notification processing are explained with reference to another flowchart shown in FIG. 14D.

### <<Transfer Notification Processing>>

At S1471, the processing results at each step up to this point are obtained from the second transfer unit 521. In the processing results here, information on the folder path used in a case of transfer to the file server, the file name, the FAX number of the source of transmission and the like is included.

At S1472, whether the FAX number of the source of transmission obtained at S1403 is a FAX number for which a notification is not necessary is determined. Specifically, in a case where the checkbox 1301 within the spam address management screen 1300 described previously is checked and the FAX number of the source of transmission is included in the spam address list managed by the spam address management unit 524, it is determined that a notification is not necessary. In a case where it is determined that the FAX number of the source of transmission obtained at S1403 is a number for which a notification is not necessary, the transfer notification processing is terminated. On the other hand, in a case where it is determined that the FAX number is not a FAX number for which a notification is not necessary, the processing advances to S1473.

At S1473, the notification destination is determined. Specifically, the notification conditions (talk room and mentioned user) associated with the FAX number of the source of transmission are obtained by referring to the notification setting list managed by the notification setting management unit 525 and determined as the notification destination. In a case where the notification conditions associated with the FAX number of the source of transmission are not set, for example, it may be possible to determine a common talk room as the notification destination.

At S1474, notification contents are generated based on the notification destination determined at S1473 and the processing results obtained at S1471, and transmitted to the application server 30. In the application server 30, the message application 406 generates UI screen data including a FAX transfer notification message based on the notification contents received from the MFP 10 and transmits the UI screen data to the user terminal 20.

The above is the contents of the transfer processing and the transfer notification processing in the MFP 10. In the present embodiment, in a case where the access to the file server (S1407) fails, a notification to the talk room (S1470) is not given. However, the configuration may be one in which the notification processing at S1470 is performed in order to notify the talk room that the transfer processing has failed. Further, in the present embodiment, in a case where the FAX number of the received FAX data is included in the spam address list, the folder name for the spam address is created, but the configuration may be one in which the file name for the spam address is created similarly.

### <Transfer Notification Display on Chat Screen>

Next, a specific example of notification display of FAX transfer on a chat screen displayed on the touch panel 201 of the user terminal 20 is explained. As described above, in the application server 30 having received the notification contents from the MFP 10, the message application 406 generates UI screen data for FAX transfer notification display and transmits the UI screen data to the user terminal 20.

Here, display control of the above-describe UI screen data including notification display in the user terminal 20 is explained. In the user terminal 20, the user ID and the password for a user to log in to the application server 30 are registered in advance. Then, in a case where a user performs the operation for opening the message application 406 by using the user terminal 20, the user ID and the password registered in advance are transmitted to the application server 30. The application server 30 having received the user ID and the password from the user terminal 20 performs user authentication based on the user ID and the password. Then, the application server 30 transmits the UI screen data of the message application 406 for the authenticated user to the user terminal 20. The user terminal 20 having received the UI screen data from the application server 30 displays the UI screen for the chat service on the touch panel 201 by using the UI screen data. By the processing such as this, the FAX transfer notification display is implemented. In the following, detailed explanation is given.

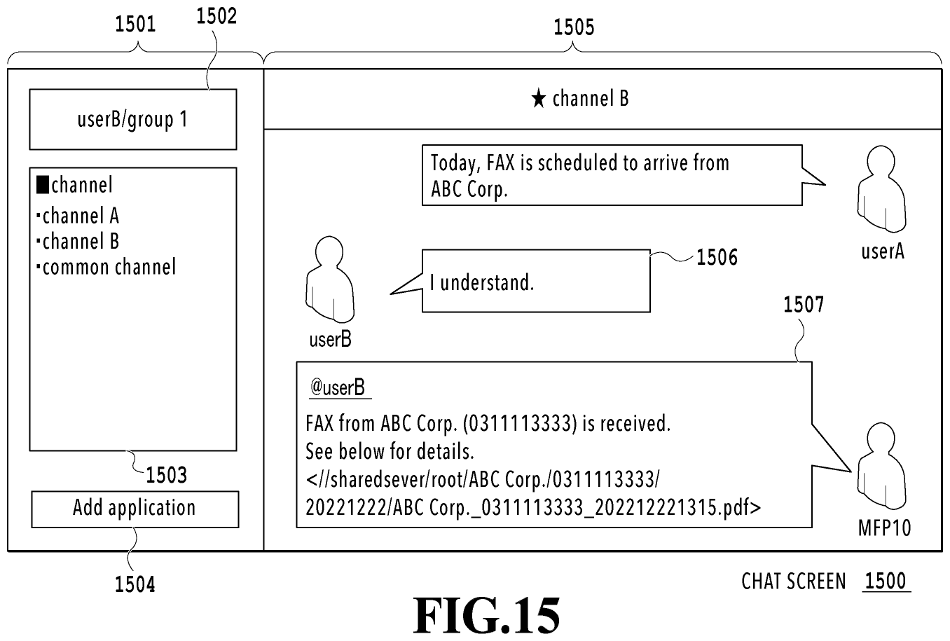

FIG. 15 is a diagram showing one example of the chat screen including a transfer notification message in a case where it is possible to obtain the registered name and the notification conditions associated with the FAX number of the source of transmission.

In an area 1502 within a left pane 1501 on a chat screen 1500 shown in FIG. 15, user information on a user operating the user terminal 20 and information on the group to which the user belongs are displayed. These pieces of user information and group information are registered in advance in association with each user in the application server 30. The application server 30 transmits these pieces of information relating to the user having succeeded in authentication to the user terminal 20 and the user and the group are displayed in the area 1502 based on the transmitted information. Further, in an area 1503 within the left pane 1501, information on the channel to which the authenticated user belongs is displayed. This channel information is also registered in advance in association with each user in the application server 30. The application server 30 transmits the channel information relating to the user having succeeded in authentication to the user terminal 20 and the channel is displayed in the area 1503 based on the transmitted information. By selecting an arbitrary channel (talk room) from among the channels displayed in the area 1503, it is made possible for a user to perform transmission and reception of messages with all the members belonging to the channel (talk room). Further, a button 1504 within the left pane 1501 is a button for adding a cooperative application. By the button 1504 being pressed down, the installation of a cooperative application is performed.

In a right pane 1505 on the chat screen 1500, a history of a message with a person registered in the channel selected by a user in the area 1503 is displayed. In this example, messages are displayed in a time series so that the more recent message is displayed at the lower portion in the right pane 1505. A message 1506 is a message that the user him/herself has transmitted. At this time, it may also be possible to add not only the character string representing a message but also file information. A message 1507 is a transfer notification message from the MFP 10. By this transfer notification message, it is possible for a user to grasp the fact that FAX data transmitted to the user him/herself has arrived and the FAX data has been transferred to the file server. In the example of this transfer notification message 1507, user B is mentioned and the folder path of the file server storing the FAX data is displayed. Here, a message example is shown in a case where it is possible to obtain the name registered in association with the FAX number of the source of transmission from the address book management unit 514 (YES is determined at S1433 and S1455). That is, the folder path and the file name including the registered name “ABC Corp.” associated with the number of the source of transmission (0311113333) are used. In addition, the notification conditions associated with the FAX number of the source of transmission have also been obtained, and therefore, a notification is given by taking “channel B” associated with the FAX number “0311113333” as the talk room of the notification destination and mentioning “user B”. As a matter of course, the transfer notification message 1507 shown in FIG. 15 is just an example and the message contents are not limited to those. For example, the configuration may be one in which a thumbnail image of FAX data is generated and added.

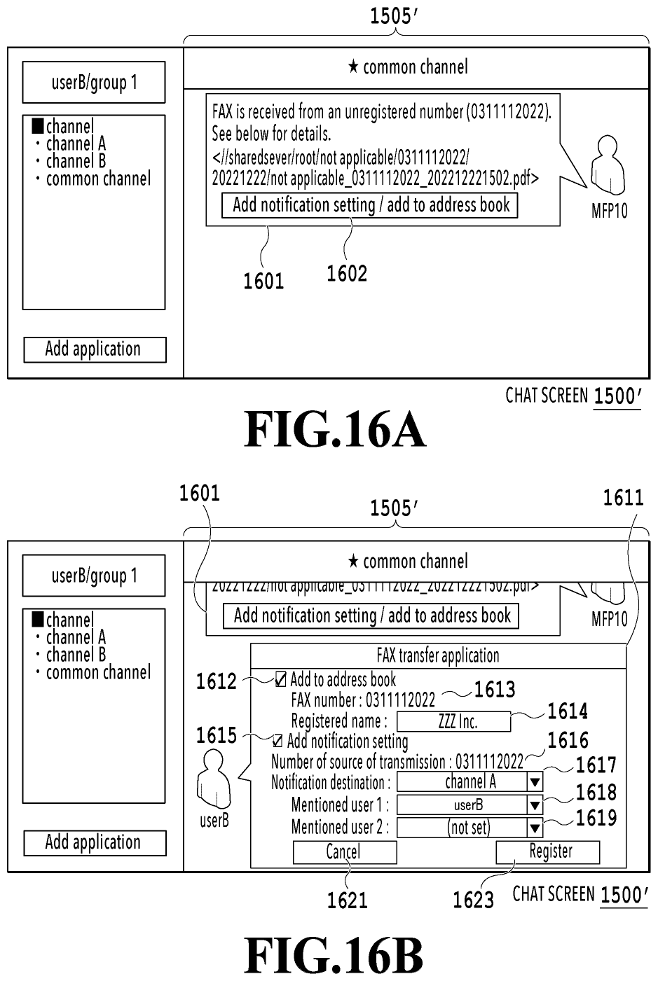

Next, one example of a transfer notification message in a case where it is not possible to obtain the registered name and the notification conditions associated with the FAX number of the source of transmission is shown in FIG. 16A. Explanation of the contents common to those in FIG. 15, such as the basic configuration of the chat screen, is omitted.

Here, in a right pane 1505′ on a chat screen 1500′ shown in FIG. 16A, a transfer notification message 1601 is displayed. The registered name associated with the FAX number of the source of transmission is not obtained from the address book management unit 514, and therefore, a message indicating that FAX data is received from an unregistered FAX number is displayed. Then, the notification conditions associated with the FAX number of the source of transmission are also not obtained, and therefore, a notification is given by taking “common channel”, which is the notification destination in a case where the notification conditions do not exist, as the notification destination talk room. Further, in the transfer notification message 1601, a button 1602 is included, which is for calling the FAX transfer application 407 of the application server 30, adding the unregistered FAX number to the address book, adding notification conditions, and so on. The button 1602 on the touch panel 201 being selected by a user is taken as a trigger, the FAX transfer application 407 activates and the state makes a transition into the state shown in FIG. 16B. As shown in FIG. 16B, in the right pane 1505′ on the chat screen 1500′, a UI screen 1611 is displayed in the format of a sub screen, on which it is possible to add the unregistered FAX number to the address book and add notification conditions.

Via the sub screen 1611, it is possible for a user to add and register the unregistered FAX number grasped by the transfer notification message to the notification conditions and/or the address book. A checkbox 1612 within the sub screen 1611 is a checkbox for designating whether or not to add and register to the address book. In a case where this checkbox 1612 is checked, an input field 1614 for inputting a name in a case where the FAX number is added is displayed as well as a number display 1613 of the FAX number to be added to the address book. Here, the button 1602 included in the transfer notification message 1601 for the FAX data received from the unregistered FAX number “0311112022” is pressed down. Because of that, the number display 1613 is displayed in an aspect in which it is not possible for a user to perform an editing operation. Of course, the configuration may be one in which editing is possible.

A checkbox 1615 within the sub screen 1611 is a checkbox for designating whether or not to add and register to the notification conditions. In a case where this checkbox 1615 is checked, first, a number display 1616 of the number of the source of transmission to be added to the notification conditions is displayed. As in the case of the above-described number display 1613, it may also be possible to display the number display 1616 in an aspect in which it is not possible for a user to perform an editing operation or the configuration may be one in which editing is possible. Further, a selection field 1617 for designating the notification destination talk room and selection fields 1618 and 1619 for designating a user to be mentioned at the time of notification are displayed, in each of which it is possible to make a selection by a pulldown menu. In a case of the selection fields 1618 and 1619, as in the case of the selection fields 1143 and 1144 within the notification condition setting screen 1140 described previously, it is also possible to leave the fields in the state where no user is selected. A button 1621 within the sub screen 1611 is a cancel button for terminating the processing without performing setting or registration and a button 1622 is a register button for completing setting and registration. In a case where the register button is pressed down, the application server 30 transmits setting information to the MFP 10. Then, the application cooperative unit 523 of the MFP 10 having received the setting information delivers the setting information to the address book management unit 514 and the notification setting management unit 525. Then, the address book management unit 514 stores the FAX number included in the received setting information in the address book data. Further, the notification setting management unit 525 associates the registered name, the notification destination talk room, and the mentioned user included in the received setting information with the FAX number and registers in the notification setting list data as new notification setting.

In the present embodiment, by taking the selection of the button 1602 within the transfer notification message 1601 by a user as a trigger, the FAX transfer application 407 is activated, but the trigger to activate the FAX transfer application 407 is not limited to this. For example, it may also be possible for a user to directly access the application server 30 and directly give instructions to activate the FAX transfer application 407. Further, in order to use the FAX transfer application 407, it is necessary to additionally install the FAX transfer application 407 in advance in the application server 30 as a cooperative application of the message application 406. In a case where the FAX transfer application 407 is not installed in advance, by taking the selection of the button 1602 within the transfer notification message 1601 by a user as a trigger, the FAX transfer application 407 is activated after the additional installation thereof as the cooperative application.

### <Sequence Between Apparatuses>

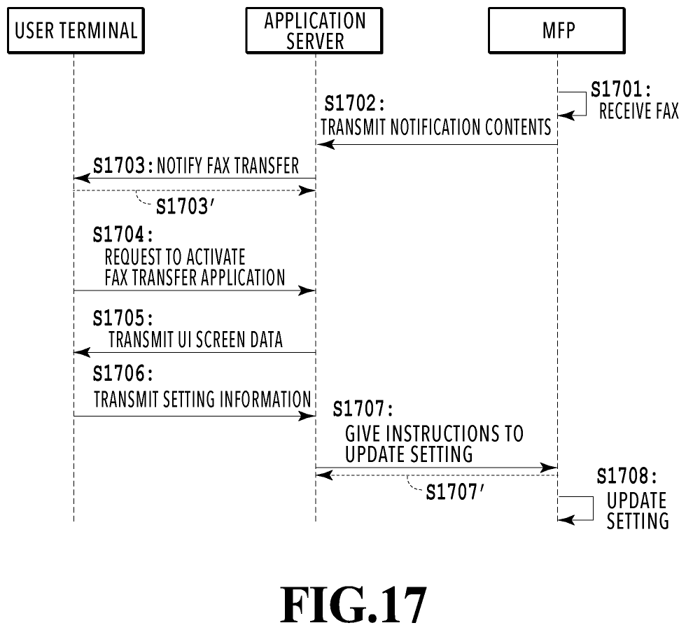

FIG. 17 is a sequence diagram showing a flow of transmission and reception of information relating to FAX transfer notification between the user terminals 20 to 22, the application server 30, and the MFPs 10 and 11. Here also, explanation is given by taking the user terminal 20 and the MFP 10 as each typical example.

First, in a case of receiving FAX data (S1701), after transferring the FAX data to a file server not shown schematically, the MFP 10 transmits a notification request for notifying a user of the fact of the transfer to the application server 30 (S1702).

The application server 30 having received the notification request causes the talk room designated in the notification request to display the chat screen 1500 including the transfer notification message in response to the access from a user via the user terminal 20 (S1703). The configuration may be one in which a user appropriately accesses the application server 30 via the user terminals 20 to 22 and checks whether there is a transfer notification message transmitted to the user him/herself (S1703′).

Upon receipt of the user operation to press down the button 1602 within the chat screen 1500′, the user terminal 20 requests the application server 30 to activate the application performing FAX transfer setting (S1704). The application server 30 having received the request activates the application performing FAX transfer setting, generates the screen data of the above-described transfer setting screen 1611, and transmits the screen data to the user terminal 20 (S1705). Then, a user sets the address book and/or the notification conditions on the transfer setting screen 1611 displayed based on the received screen data. In a case where a user presses down the Register button 1623 after completing the setting operation, the setting information described previously is transmitted from the user terminal 20 to the application server 30 (S1706). The application server 30 having received the setting information transmits instructions to update the address book and/or the notification setting to the MFP 10 along with the received setting information (S1707). The configuration may be one in which the MFP 10 accesses the application server 30 periodically and checks whether there is setting information that the MFP 10 should obtain (S1707).

The MFP 10 having received the setting information along with the updating instructions updates the information on the address book and/or the notification setting in accordance with the received setting information (S1708). Specifically, the address book management unit 514 associates the FAX number and the registered name with each other, which are designated in the setting information, and adds and registers the FAX number and the registered name to the address book data. Alternatively, the notification setting management unit 525 associates the FAX number of the source of transmission and the designated notification conditions (notification destination talk room and mentioned user) with each other and adds and registers them to the notification setting list data. It may also be possible to transmit a notification to the effect that updating is completed to the application server 30 after the setting updating is completed.

### Modification Example

In the above-described embodiment, the case is explained where it is made possible to edit the address book and/or the notification setting stored in the MFP 10 and perform the setting updating by the user operation via the chat screen 1500 displayed on the user terminals 20 to 22. Further, a case is explained as a modification example where it is made possible to edit the spam address stored in the MFP 10 and perform the setting updating by the user operation on the talk room. Explanation of the contents common to those of the first embodiment, such as the basic system configuration and the hardware configuration of the apparatus, is omitted and in the following, different points are explained.

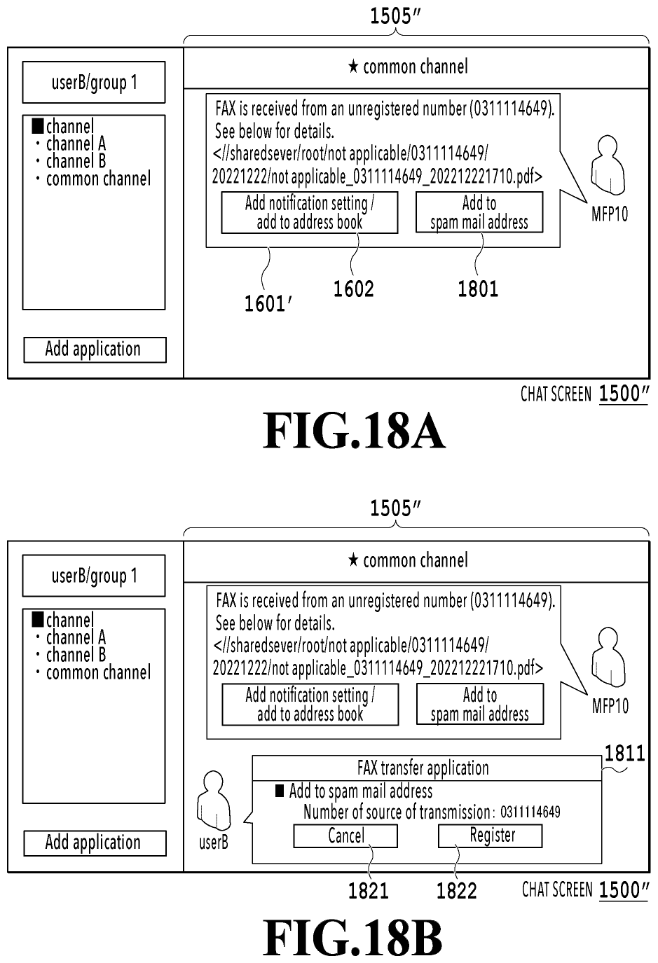

FIG. 18A is a diagram showing one example of a chat screen 1500″ according to the present modification example. The chat screen 1500″ differs from the chat screen 1500′ in FIG. 16A in that a button 1801 is provided within a transfer notification message 1601′, which is a button for adding and registering an unregistered FAX number grasped by a transfer notification message to the spam address list as a spam FAX number. In a case of the present modification example also, by taking the button 1801 being selected by a user as a trigger, the FAX transfer application 407 activates and the chat screen 1500″ makes a transition into the state shown in FIG. 18B. As shown in FIG. 18B, in a right pane 1505″ on the chat screen 1500″, a UI screen 1811 for a user to register an unregistered FAX number to the spam address list is displayed in the format of a sub screen. It is possible for a user to add and register the unregistered FAX number grasped by the transfer notification message to the spam address list.

A button 1821 within the UI screen 1811 is a cancel button for terminating the processing without performing registration and a button 1822 is a register button for completing registration. In a case where the register button is pressed down, the application server 30 transmits setting information to the MFP 10. Then, the application cooperative unit 523 of the MFP 10 having received the setting information delivers the setting information to the spam address management unit 524 and the spam address management unit 524 stores the FAX number included in the setting information in the spam address list data.

The configuration may be one in which it is made possible to edit the spam address list stored in the MFP 10 by the operation on the talk room by a user currently utilizing the chat service as described above.

As explained above, according to the present embodiment, it is possible for the MFP 10 having received FAX data to notify the talk room of the transfer of the FAX data via the chat service. In addition, at the time of notification, a user to be mentioned can be set, and therefore, it is also possible to give a notification to a desired user. Then, it is possible for a user currently utilizing the chat service to add an unregistered FAX number to the address book or the spam address list stored in the MFP 10, change the notification setting of FAX transfer, and so on, by the operation on the talk room.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve convenience of a user by reducing time an effort for the setting work relating to address information on a source of transmission in a case where data whose address information on the source of transmission is unknown is received.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-041328, filed Mar. 15, 2023 which is hereby incorporated by reference wherein in its entirety.

What is claimed is:

1. A data transfer apparatus capable of communicating with a server providing a chat service, the data transfer apparatus comprising:
one or more memories storing instructions; and
one or more processors executing the instructions to perform:
managing a name representing a source of transmission of received data and address information on the source of transmission in association with each other;
transferring received data to an external device; and
providing the server with information for a user currently utilizing the chat service to grasp that the transfer has been performed, wherein
in the managing, based on instructions from the user in the chat service, the name representing the source of transmission of the received data and the address information on the source of transmission of the received data are managed in association with each other.

2. The data transfer apparatus according to claim 1, wherein
the managed address information on the source of transmission is used as a file name or a folder path in a case where the transfer is performed.

3. The data transfer apparatus according to claim 1, wherein
the one or more processors execute the instructions to perform:
managing a talk room in the chat service and the address information on the source of transmission in association with each other based on instructions from the user.

4. The data transfer apparatus according to claim 3, wherein
in the providing, in a case where the address information indicating the source of transmission of the received data is managed, contents for the server to give a notification to the effect that the transfer has been performed for the talk room associated with the managed address information are provided.

5. The data transfer apparatus according to claim 4, wherein
in a case where a talk room in the chart service and the address information on the source of transmission are managed in association with each other, a user to be mentioned in a case where a notification is given to the talk room is managed in association with the address information on the source of transmission and
in the contents, information identifying the user managed as a target to be mentioned is included.

6. The data transfer apparatus according to claim 5, wherein
in a case where a talk room in the chart service and the address information on the source of transmission are managed in association with each other, the management target is updated based on instructions from a user mentioned in the notification in the chat service.

7. The data transfer apparatus according to claim 1, wherein
the one or more processors execute the instructions to perform:
managing the address information on the source of transmission of the received data is managed as a spam address based on instructions from the user.

8. The data transfer apparatus according to claim 7, wherein
in a case where the received data is data whose source of transmission is address information managed as the spam address, the providing is not performed.

9. The data transfer apparatus according to claim 1, wherein
the data is FAX data.

10. A control method of a data transfer apparatus capable of communicating with a server providing a chat service, the control method comprising the steps of:
managing a name representing a source of transmission of received data and address information on the source of transmission in association with each other;
transferring received data to an external device; and
providing the server with information for a user currently utilizing the chat service to grasp that the transfer has been performed, wherein
in the managing, based on instructions from the user in the chat service, the name representing the source of transmission of the received data and the address information on the source of transmission of the received data are managed in association with each other.

11. A non-transitory computer readable storage medium storing a program for causing a computer to perform a control method of a data transfer apparatus capable of communicating with a server providing a chat service, the control method comprising the steps of:
managing a name representing a source of transmission of received data and address information on the source of transmission in association with each other;
transferring received data to an external device; and
providing the server with information for a user currently utilizing the chat service to grasp that the transfer has been performed, wherein
in the managing, based on instructions from the user in the chat service, the name representing the source of transmission of the received data and the address information on the source of transmission of the received data are managed in association with each other.
